(19) United States
(12) Patent Application Publication
(10) Pub. No.: US 2018/0115512 A1
(43) Pub. Date: Apr. 26, 2018

(54) METHODS AND SYSTEMS FOR DOWNLOADING A FILE

(71) Applicant: Terry Yukio Otsubo, Duluth, GA (US)

(72) Inventor: Terry Yukio Otsubo, Duluth, GA (US)

(73) Assignee: American Megatrends, Inc., Norcross, GA (US)

(21) Appl. No.: 15/333,760

(22) Filed: Oct. 25, 2016

(51) Int. Cl. H04L 29/12; G06F 17/30; H04L 29/08

(52) U.S. Cl. CPC H04L 61/1582; G06F 17/30864; H04L 67/02; H04L 67/06; G06F 17/30887

(57) ABSTRACT

Example embodiments of the disclosed systems and methods for downloading a file allow downloads to occur from any URL path in the domain. When a web guest (or user) accesses a website, the application layer reads the URL entered by the web guest. Based on the URL, the application layer checks for a URL string. If a URL string is found, the application layer determines if the URL string contains a file designation. If a file designation is found within the URL string, the application layer processes the request, which may include one or more of the following functions: verifies file, verifies type, determines access rights, determines storage location, determines requirements, allows download, restricts download, displays error message, and logs transaction.

### TECHNICAL FIELD

This disclosure is related to methods and systems for downloading a file; more particularly, downloading a file at a webserver.

### BACKGROUND

Typically, a user downloads a file by clicking on a hyperlink on a website. This can be challenging because the user has to find the hyperlink of the file at the website, especially if the website has many sites and/or content and if the website changes frequently.

Desirable in the art is an improved method and system for downloading a file that would improve upon the conventional method and system.

### SUMMARY

Example embodiments of the present disclosure provide systems of downloading a file. Briefly described, in architecture, one example embodiment of the system, among others, can be implemented as follows: a processing device; memory storing a file download module which has instructions that are executed by the processing device, the instructions including the following logics: open an internet browser that receives a URL; determine whether a query string is present in the URL; responsive to determining that the query string is present in the URL, determine whether a file name is present in the URL; responsive to determining that the file name is present in the URL, query a data source for a file having a file name that matches the file name present in the URL; and responsive to determining that the file at the data source matches the file name present in the URL, initiate protocol for downloading the file at the data source.

Embodiments of the present disclosure can also be viewed as providing methods for downloading a file. In this regard, one embodiment of such a method, among others, can be broadly summarized by the following steps: receiving a query; determining whether a file name is present in the query; responsive to determining that the file name is present in the query, querying a data source for a file having a file name that matches the file name present in the query; and responsive to determining that the file at the data source matches the file name present in the query, initiate protocol for downloading the file at the data source

### BRIEF DESCRIPTION OF THE DRAWINGS

The accompanying drawings illustrate preferred embodiments of the invention, as well as other information pertinent to the disclosure, in which:

FIG. 1 is a system view of a file download system in accordance with an example embodiment of the disclosure;

FIG. 2 is a block diagram that illustrates electrical components in a generic computing device in accordance with an example embodiment of the disclosure;

FIG. 3 is a block diagram of a server having a file download module in accordance with an example embodiment of the disclosure;

FIG. 4 is a flowchart for downloading a file in a server through a web browser over the Internet in accordance with an example embodiment of the disclosure;

FIG. 5 is a form-fill layout that can be utilized by a file download module in accordance with an example embodiment of the disclosure;

FIG. 6 is a web browser screen for submitting a file query for download through a URL entry in accordance with an example embodiment of the disclosure; and

FIG. 7 is a web browser screen for submitting a file query for download through a URL entry on an alternate website in accordance with an example embodiment of the disclosure.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which a file can be downloaded in a server through a web browser over the Internet in accordance with an embodiment of the disclosure.

Example embodiments of the systems and methods disclosed herein allow downloads to occur from any URL path in the domain. When a web guest (or user) accesses a website, the application layer reads the URL entered by the web guest. Based on the URL, the application layer checks for a URL string. If a URL string is found, the application layer determines if the URL string contains a file designation. If a file designation is found within the URL string, the application layer processes the request, which may include one or more of the following functions: verifies file, verifies type, determines access rights, determines storage location, determines requirements (such as acknowledgment through a clickwrap agreement message: “Click here to agree to the license agreement and begin your download.”), allows download, restricts download, displays error message, and logs transaction.

In an example embodiment of a method for downloading a file, a user clicks a link to initiate a download from their Internet browser. This initiates an HTTP GET request to the website. An application checks if the URL contains a query string. If so, it checks if the query string contains a file name. If the query string contains a file name, the application queries the file database for a file with the name in the query string. If the file is found in the file database, the application checks the access level of the file. If the access level is PUBLIC, then the user is able to download the requested file. If the access level is SPECIAL, the user is sent to a download request form. If the access level is REGISTERED, the user is prompted to log in first (or if logged in already) and is ten able to immediately download the requested file. If the access level is NDA or INTERNAL, then the user is prompted that the file does not exist and is sent to the homepage or resources page of the website.

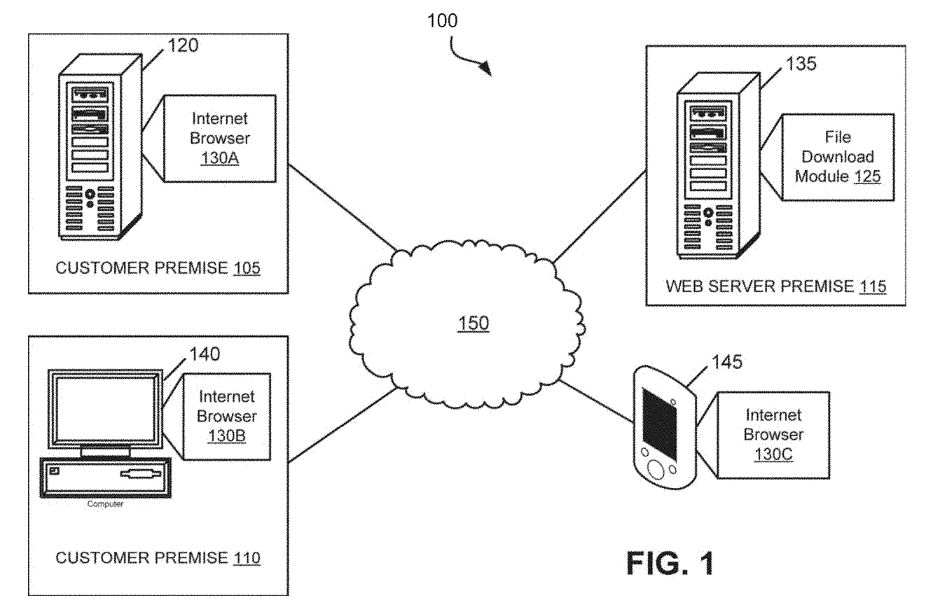

Referring to FIG. 1, file downloading system 100 generally includes at least one customer premise 105 that may include server 120 that runs internet browser 130A, at least one customer premise 110 that runs internet browser 130B on computer 140, at least one web server 115 that runs file download module 125 on, for example, server 135, and portable devices 145 that run internet browser 130C, that can all connect to the Internet. The premises 105, 110, server 115 and the portable devices 145 may be connected to network 150, such as the Internet, telephone network system, and cellular network system.

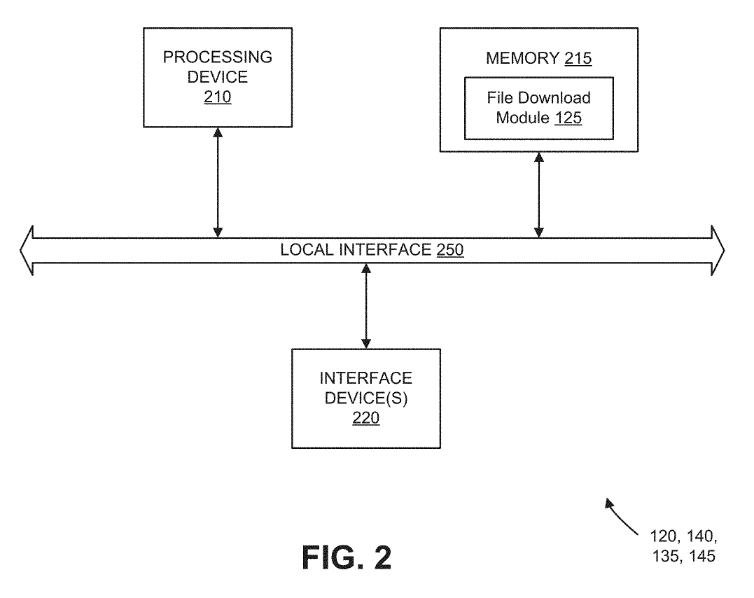

FIG. 2 is a block diagram that illustrates electrical components in a generic computing device in accordance with an embodiment of the disclosure. Any of server 120, computer 140, web server 135, and portable device 145 may comprise processing device 210, memory 215, in which file download module 125 is stored, and one or more interface devices 220 that are connected to local interface 250 such that processing device 210, memory 215 and interface device 220 may interface with each other.

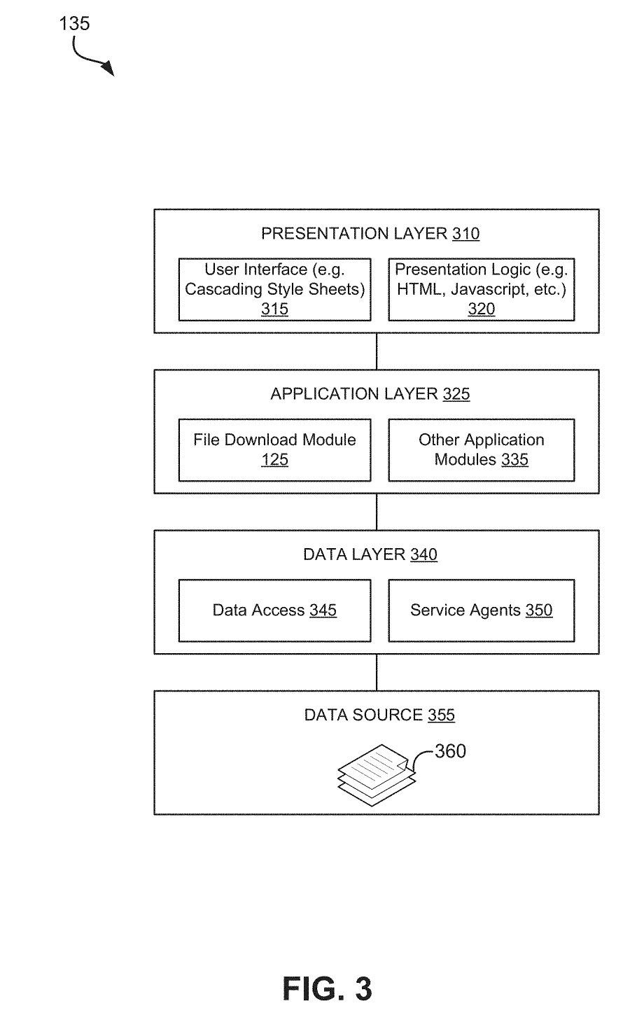

FIG. 3 is a block diagram of a server having a file download module in accordance with an example embodiment of the disclosure. In an example embodiment, web server 135 comprises presentation layer 310, application layer 325, data layer 340, and data source 355. Presentation layer 310 comprises User interface 315 and presentation logic 320. User interface 315 configures the style of the user interface such as in cascading style sheets, as a non-limiting example. Presentation logic 320 comprises the language used to present the user interface, such as HTML and Javascript as non-limiting examples. Application layer 325 comprises file download module 325 and other application modules 335 such as, for example, a clickwrap license agreement. Data layer 340 comprises data access module 345 and service agents 350. Data source 355 comprises the source of data 360.

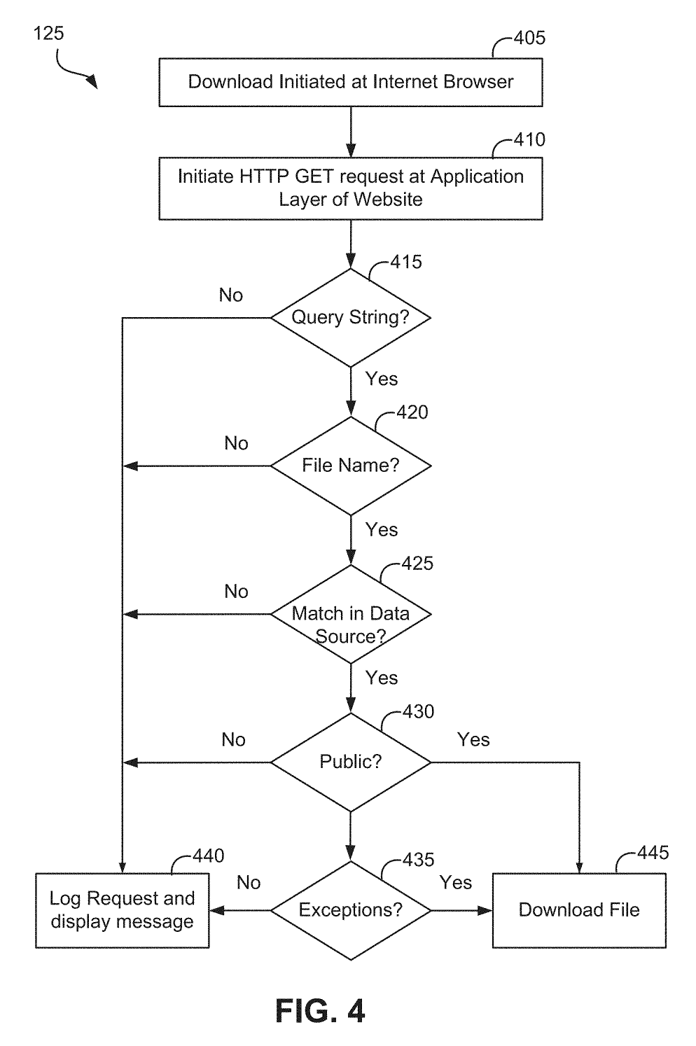

FIG. 4 is a flowchart for downloading a file in a server through a web browser over the Internet in accordance with an example embodiment of the disclosure. In block 405, a download is initiated through an internet browser. In block 410, an HTTP GET request is initiated at the application layer of the website. In block 415, a determination is made as to whether the request contains a query string. If it does not, the process moves to block 440 where the request is logged and a message is displayed. If the request does contain a query string, then the process moves to block 420 in which a determination is made as to whether the query string contains a file name. If it does not contain a file name, the process moves to block 440 where the request is logged and a message is displayed.

If the query string does contain a file name, the process moves to block 425 in which a determination is made as to whether the file name matches a file contained in the data source. If the file name does not match a file in the data source, then the process moves to block 440 where the request is logged and a message is displayed. If the file name does match a file in the data source, then the process moves to block 430 in which a determination is made as to whether the file name is accessible by the public. If the file is not designated as accessible by the public, then the process moves to block 440 where the request is logged and a message is displayed. If the file is determined to be accessible by the public, then, in block 445, the file is downloaded. In block 435, a determination is made as to whether there may be an exception that would allow for the user to download the file even though the file is not accessible by the public. If there are no exceptions, then, in block 440, the request is logged and a message is displayed. If a valid exception exists, then, in block 445, the file is downloaded.

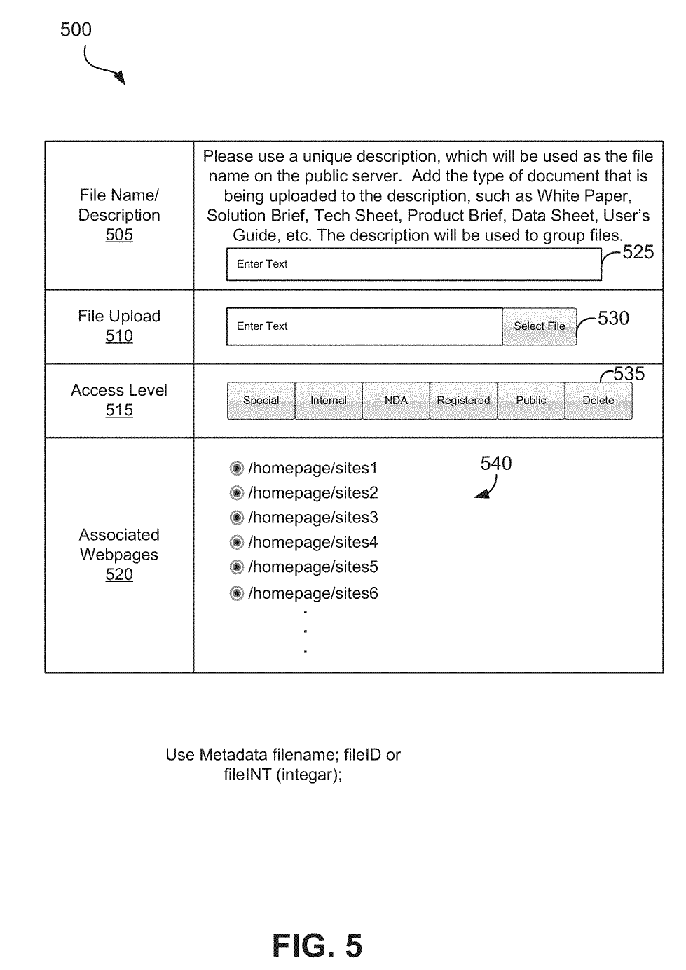

FIG. 5 provides form-fill layout 500 that may be utilized to set up a file that may be downloaded by a file download module in accordance with an example embodiment of the disclosure. In an example embodiment, form-fill layout 500 comprises file name/description field 505, file upload field 510, access level field 515, and associated webpages 520. File name description field 505 is used to enter a unique description of the file, which may be used as the file name on a server. The description may comprise the type of document that is being uploaded, such as White Paper, Solution Brief, Tech Sheet, Product Brief, Data Sheet, and User's Guide as non-limiting examples. In an example embodiment, the description is used to group files.

File upload field 510 may comprise the actual file name, and the “select File” button may be selectable to Browse a file directory to choose the file by file name. When a particular file is chosen, the file name for that file may be populated into file upload field 510. Access level field 515 may comprise one or more selectable buttons for setting the access level of the selected file. Button selections may include “Special,” “Internal,” “NDA,” “Registered,” “Public,” and “Delete,” as non-limiting examples. The delete selection may proscribe a special function for deleting the file from data source 355 of FIG. 3. Associated webpages field 520 may include additional URLs that are related to the file.

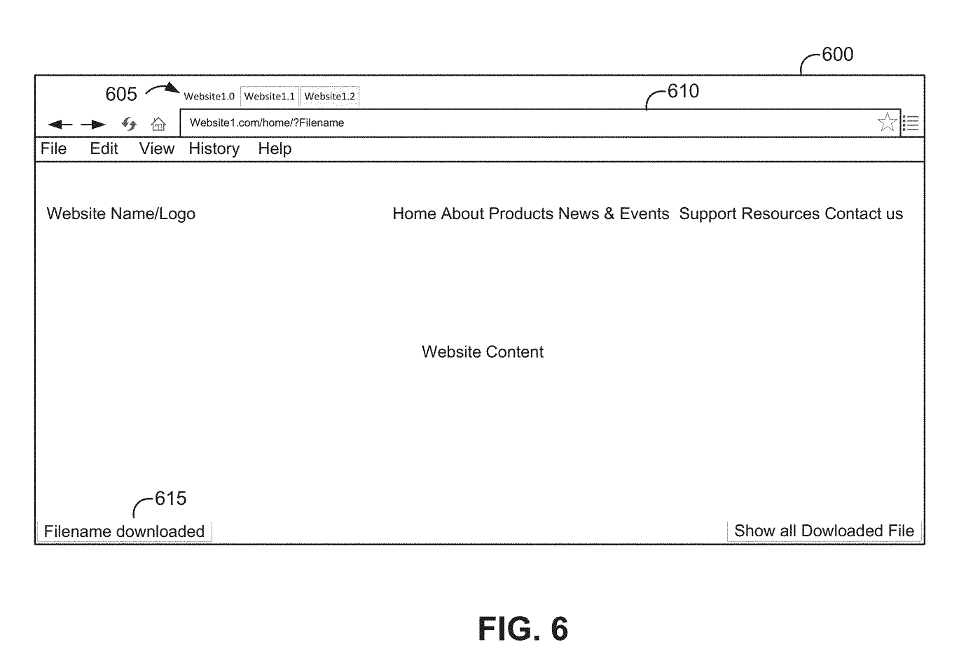

FIG. 6 provides web browser screen 600 for submitting a file query for download through a URL entry in accordance with an example embodiment of the disclosure. Website field 605 comprises the website that is being used to submit the query for the file download. URL field 610 comprises the field into which the query for the file download is entered. Once the query is entered and a file download is completed, File downloaded field 615 provides an indication that the requested file has been downloaded.

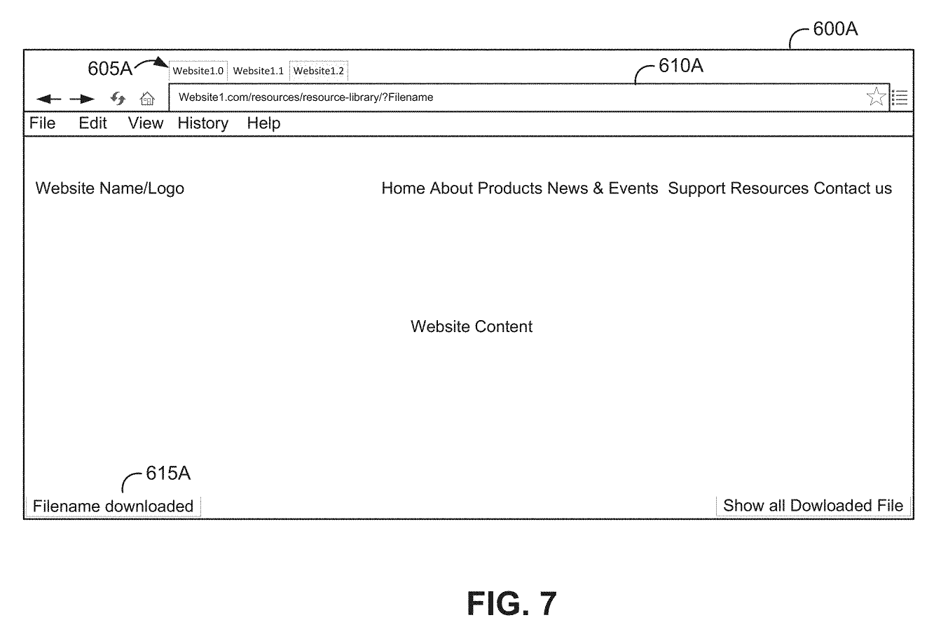

FIG. 7 provides web browser screen 600A for submitting a file query for download through a URL on an alternate website entry in accordance with an example embodiment of the disclosure. Website field 605A comprises the website that is being used to submit the query for the file download. A query may be performed through the same query/database despite being on a different website. URL field 610A comprises the field into which the query for the file download is entered. Once the query is entered and a file download is completed, File downloaded field 615A provides an indication that the requested file has been downloaded.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. A web server for downloading a file comprising:
a processing device;
memory storing a file download module which has instructions that are executed by the processing device, the instructions including the following logics:
open an internet browser that receives a URL;
determine whether a query string is present in the URL;
responsive to determining that the query string is present in the URL, determine whether a file name is present in the URL;
responsive to determining that the file name is present in the URL, query a data source for a file having a file name that matches the file name present in the URL; and
responsive to determining that the file at the data source matches the file name present in the URL, initiate protocol for downloading the file at the data source.

2. The web server of claim 1, wherein the file download module is implemented at an application layer of a website.

3. The web server of claim 2, wherein the determining whether a query string is present in the URL comprises initiating an HTTP GET request at the application layer of the website.

4. The web server of claim 1, wherein the instructions further include the following logics:
determine whether the file at the data source that matches the file name present in the URL is designated as a public file; and
responsive to determining that the file at the data source that matches the file name present in the URL is designated as a public file, initiate protocol for downloading the file at the data source.

5. The web server of claim 1, wherein the instructions further include the following logics:
determine whether the file at the data source that matches the file name present in the URL is designated as a non-public file; and
responsive to determining that the file at the data source that matches the file name present in the URL is designated as a non-public file, determine whether the file at the data source is designated as at least one of the following: special, internal, non-disclosure agreement, registered, and delete.

6. The web server of claim 5, wherein the instructions further include the following logic:
responsive to determining that the file at the data source is designated as special, internal, non-disclosure agreement, registered, and/or delete, initiate protocol for determining whether a user has access to the file based on the designation of the file.

7. A non-transient computer readable medium comprising software with instructions for:
receiving a query;
determining whether a file name is present in the query;
responsive to determining that the file name is present in the query, querying a data source for a file having a file name that matches the file name present in the query; and
responsive to determining that the file at the data source matches the file name present in the query, initiate protocol for downloading the file at the data source.

8. The computer readable medium of claim 7, wherein the query is received through a URL entry.

9. The computer readable medium of claim 7, wherein the instructions are implemented at an application layer of a website.

10. The computer readable medium of claim 9, wherein the determining whether a query string is present in the URL comprises initiating an HTTP GET request at the application layer of the website.

11. The computer readable medium of claim 7, wherein the instructions further include:
determining whether the file at the data source that matches the file name present in the query is designated as a public file; and
responsive to determining that the file at the data source that matches the file name present in the query is designated as a public file, initiating protocol for downloading the file at the data source.

12. The computer readable medium of claim 7, wherein the instructions further include:
determining whether the file at the data source that matches the file name present in the query is designated as a non-public file; and
responsive to determining that the file at the data source that matches the file name present in the query is designated as a non-public file, determine whether the file at the data source is designated as at least one of the following: special, internal, non-disclosure agreement, registered, and delete.

13. The computer readable medium of claim 12, wherein the instructions further include:
responsive to determining that the file at the data source is designated as special, internal, non-disclosure agreement, registered, and/or delete, initiating protocol for determining whether a user has access to the file based on the designation of the file.

14. A method comprising:
receiving a query;
determining whether a file name is present in the query;
responsive to determining that the file name is present in the query, querying a data source for a file having a file name that matches the file name present in the query; and
responsive to determining that the file at the data source matches the file name present in the query, initiate protocol for downloading the file at the data source.

15. The method of claim 14, wherein the query is received through a URL entry.

16. The method of claim 14, wherein the instructions are implemented at an application layer of a website.

17. The method of claim 14, wherein the determining whether a query string is present in the URL comprises initiating an HTTP GET request at the application layer of the website.

18. The method of claim 14, wherein the instructions further include:
determining whether the file at the data source that matches the file name present in the query is designated as a public file; and
responsive to determining that the file at the data source that matches the file name present in the query is designated as a public file, initiating protocol for downloading the file at the data source.

19. The method of claim 14, wherein the instructions further include:
determining whether the file at the data source that matches the file name present in the query is designated as a non-public file; and
responsive to determining that the file at the data source that matches the file name present in the query is designated as a non-public file, determine whether the file at the data source is designated as at least one of the following: special, internal, non-disclosure agreement, registered, and delete.

20. The method of claim 19, wherein the instructions further include:
responsive to determining that the file at the data source is designated as special, internal, non-disclosure agreement, registered, and/or delete, initiating protocol for determining whether a user has access to the file based on the designation of the file.
